(19) United States
(12) Patent Application Publication
(10) Pub. No.: US 2025/0067889 A1
(43) Pub. Date: Feb. 27, 2025

(54) TIME PRESERVING FULL WAVEFORM INVERSION (TP-FWI)

(71) Applicant: SAUDI ARABIAN OIL COMPANY, Dhahran (SA)

(72) Inventors: Young Seo Kim, Dhahran (SA); Adam J. Fox, Dhahran (SA); Krzysztof K. Sliz, Dhahran (SA)

(73) Assignee: SAUDI ARABIAN OIL COMPANY, Dhahran (SA)

(21) Appl. No.: 18/453,839

(22) Filed: Aug. 22, 2023

(51) Int. Cl. G01V 1/28; G01V 1/30

(52) U.S. Cl. CPC G01V 1/282; G01V 1/305; G01V 2210/6222

(57) ABSTRACT

Systems and methods for time preserving full waveform inversion are disclosed. The methods may include acquiring, using a seismic acquisition system, a seismic dataset and, using a seismic processor, obtaining, from the seismic dataset, an event in two-way traveltime (TWT) and a velocity model in TWT, and converting the velocity model in TWT into a velocity model in depth. The methods further include producing a final velocity model in depth, where the final velocity model is produced using a full waveform inversion (FWI), the velocity model in depth, and a TWT-preserving method preserves the event in TWT at each iteration of the FWI; and forming a seismic image in depth using the final velocity model in depth and the seismic dataset. The methods further include identifying, using a seismic interpretation workstation and based on the seismic image in depth, a drilling target; and planning a borehole path to the drilling target.

### BACKGROUND

An accurate initial velocity model is essential for successful application of FWI in the absence of low frequency information. Such a model may be generated from refraction tomography, reflection traveltime tomography, and migration velocity analysis. Adding constraints from geological interpretation can further help guide the velocity model building process. Building the velocity model usually begins with tying key velocity boundaries to the key reflectors in the TWT (Two Way Time) domain. However, a solution based on tomography or velocity analysis will update the depth-interval velocities, not the depth of the velocity boundaries (despite the fact that the velocity above the boundary has changed). Therefore, the position of reflectors of an FWI solution in TWT will not match the original input velocity model. Furthermore, since reflection events from pre-stack seismic gathers are generally not used to constrain the FWI solution, that solution will tend to diverge from the input velocity model as FWI iterations progress.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments are disclosed related to methods for time preserving full waveform inversion. The methods include receiving, from a seismic acquisition system, a seismic dataset and using a seismic processor to obtain, from the seismic dataset, an event in two-way traveltime (TWT) and a velocity model in TWT. The method further includes converting the velocity model in TWT into a velocity model in depth and producing a final velocity model in depth, where the final velocity model is produced using a full waveform inversion (FWI), the velocity model in depth, and a TWT-preserving method preserves the event in TWT at each iteration of the FWI. The methods also includes forming a seismic image in depth using the final velocity model in depth and the seismic dataset. The methods further include identifying, using a seismic interpretation workstation and based, at least in part, on the seismic image in depth, a drilling target; and planning, using a borehole planning system, a borehole path to the drilling target.

In general, in one aspect, embodiments are disclosed related to systems configured for time preserving full waveform inversion. The systems include a seismic acquisition system, a seismic processor, and a seismic interpretation workstation. The seismic acquisition system is configured to receive a seismic dataset; a seismic processor, configured to: obtain, from the seismic dataset, an event in two-way traveltime (TWT); obtain, from the seismic dataset, a velocity model in TWT; convert the velocity model in TWT into a velocity model in depth; produce a final velocity model in depth, wherein: the final velocity model is produced using a full waveform inversion (FWI) and the velocity model in depth, and a TWT-preserving method preserves the event in TWT at each iteration of the FWI; and form a seismic image in depth using the final velocity model in depth and the seismic dataset. The systems further include a seismic interpretation workstation, configured to identify a drilling target based, at least in part, on the seismic image in depth; and a borehole planning system, configured to plan a borehole path to the drilling target.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a seismic acquisition system in accordance with one or more embodiments.

FIG. 2 shows a seismic shot gather in accordance with one or more embodiments.

FIG. 3 shows misplacement of seismic event during conventional full waveform inversion in accordance with one or more embodiments.

FIG. 4 shows correct placement of seismic event during two-way traveltime preserving full waveform inversion in accordance with one or more embodiments.

FIG. 5 shows a workflow in accordance with one or more embodiments.

FIG. 6 shows pseudocode of the two-way traveltime preserving method in accordance with one or more embodiments.

FIG. 7 shows initial velocity model in depth converted from original velocity model in two-way traveltime in accordance with one or more embodiments.

FIG. 8 shows an inverted velocity model obtained from the conventional full waveform inversion in accordance with one or more embodiments.

FIG. 9 shows inverted models obtained from the two-way traveltime preserving full waveform inversion in accordance with one or more embodiments.

FIG. 10 shows an original velocity model in two-way traveltime in accordance with one or more embodiments.

FIG. 11 shows a conventionally inverted velocity model in depth converted from depth to two-way traveltime in accordance with one or more embodiments.

FIG. 12 shows a two-way traveltime preserving inverted velocity model converted from depth to two-way traveltime in accordance with one or more embodiments.

FIG. 13 shows a flowchart in accordance with one or more embodiments.

FIG. 14 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

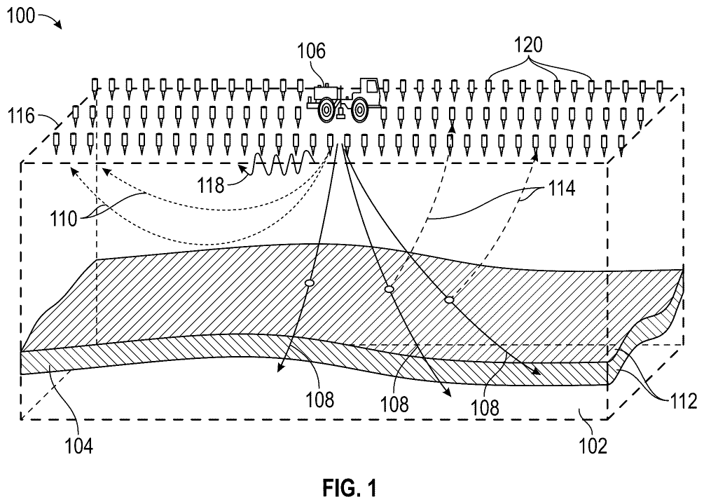

In the following description of FIGS. 1-14, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a seismic dataset” includes reference to one or more of such seismic datasets.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Methods and systems for Full Waveform Inversion (FWI) that preserve two-way traveltime information of a starting velocity model are presented. FWI is an optimization-based depth model building technology that seeks to convert seismic datasets into models of the velocity of the subsurface (and possibly other geophysical parameters, as well). An objective function must be minimized during FWI that measures the difference between modeled and observed seismic data. Various techniques exist to minimize the objective function, including steepest descent and gradient-based methods.

Low frequency information and a good starting velocity model are essential for successful application of FWI. The initial velocity model may be generated from the combination of various techniques such as refraction tomography, reflection traveltime tomography, and migration velocity analysis. Additionally, interpretation of the subsurface based on geological constraints may help stabilize the velocity model building process.

Starting velocity models may also be built that tie key reflectivity events in two-way traveltime (TWT) to key velocity boundaries in depth. An example of this would be a velocity model in depth which has been converted from a velocity model in TWT. In this case, an event in TWT would be pegged to a particular depth. The maximum depth of the initial velocity model in depth may be deeper than the maximum penetration depth obtained from FWI with refracted or diving waves (which have a penetration depth of only about ⅕ of the maximum offset). Thus, the velocities may be updated by FWI only in the shallow area of the model. In this case, if a reference layer in TWT used in the model building process corresponds to a location within or deeper than the maximum modeled depth of FWI, the TWT of the layer event may be altered, thus no longer tying to the TWT of the reflection event in the seismic data. Conventional FWI solutions (which update solely in the depth domain) will therefore diverge from the input TWT of events in the seismic data as iterations progress.

To resolve the TWT-depth relationship break, a novel FWI method is presented that preserves the TWT information during FWI iterations. By using the proposed FWI method, a final inverted velocity model in depth may be obtained that keeps the TWT information of reflectors contained in the starting model, thus preserving consistency with the starting model.

FIG. 1 shows a seismic survey (100) of a subterranean region of interest (102), which may contain a hydrocarbon reservoir (104). In some cases, the subterranean region of interest (102) may lie beneath a lake, sea, or ocean. In other cases, the subterranean region of interest (102) may lie beneath an area of land. The seismic survey (100) may utilize a seismic source (106) that generates radiated seismic waves (108). The type of seismic source (106) may depend on the environment in which it is used, for example on land the seismic source (106) may be a vibroseis truck or an explosive charge, but in water the seismic source (106) may be an airgun. The radiated seismic waves (108) may return to the surface of the earth (116) as refracted seismic waves (110) or may be reflected by geological discontinuities (112) and return to the surface as reflected seismic waves (114). The radiated seismic waves may propagate along the surface as Rayleigh waves or Love waves, collectively known as “ground-roll” (118). Vibrations associated with ground-roll (118) do not penetrate far beneath the surface of the earth (116) and hence are not influenced, nor contain information about, portions of the subterranean region of interest (102) where hydrocarbon reservoirs (104) are typically located. Seismic receivers (120) located on or near the surface of the earth (116) detect reflected seismic waves (114), refracted seismic waves (110) and ground-roll (118).

The data recorded by the seismic receivers (120) may be transmitted to a seismic recording facility located in the neighborhood of the seismic survey (100). The seismic recording facility may be one or more seismic recording trucks. The plurality of seismic receivers (120) may be in digitally or analogic telecommunication with the seismic recording facility. The telecommunication may be performed over telemetry channels that may be electrical cables, such as coaxial cables, or may be performed wirelessly using wireless systems, such as Wi-Fi or Bluetooth. Digitization of the seismic data may be performed at each seismic receiver (120), or at the seismic recording facility, or at an intermediate telemetry node (not shown) between the seismic receiver (120) and the seismic recording facility.

The observed seismic data may be stored on non-transitory computer memory. The computer memory may be one or more computer hard-drives, or one or more computer memory tapes, or any other convenient computer memory media familiar to one skilled in the art. The seismic data may be transmitted to a computer for processing. The computer may be located in or near the seismic recording facility or may be located at a remote location, that may be in another city, country, or continent. The seismic data may be transmitted from the seismic recording facility to a computer for processing. The transmission may occur over a network that may be a local area network using an ethernet or Wi-Fi system, or alternatively the network may be a wide area network using an internet or intranet service. Seismic data may be transmitted over a network using satellite communication networks. Most commonly, because of its size, seismic data may be transmitted by physically transporting the computer memory, such as computer tapes or hard drives, in which the seismic data is stored from the seismic recording facility to the location of the computer to be used for processing.

When performing FWI on seismic data, cycle skipping may occur, where the timing of the modeled waveform (predicted by a velocity model in depth) differs from that of the observed waveform (obtained from recorded seismic data) by more than half a cycle. This serves to guide the minimization of the objective function into a local minimum, thus giving the appearance of having a velocity model in depth that fits the data. However, in reality, a possibly real structure in the velocity model in depth has been shifted deeper or shallower from where it truly exists. A priori velocity model constraints, as well as low frequency seismic data, may help determine the correct kinematic structure, thereby avoiding this problem. Having a large offset to depth ratio for the area under study can also help avoid the problem by using refracted and diving waves to constrain the FWI solution. Offsets in the seismic acquisition experiment, in this case, would need to be multiple times that of the depth being investigated.

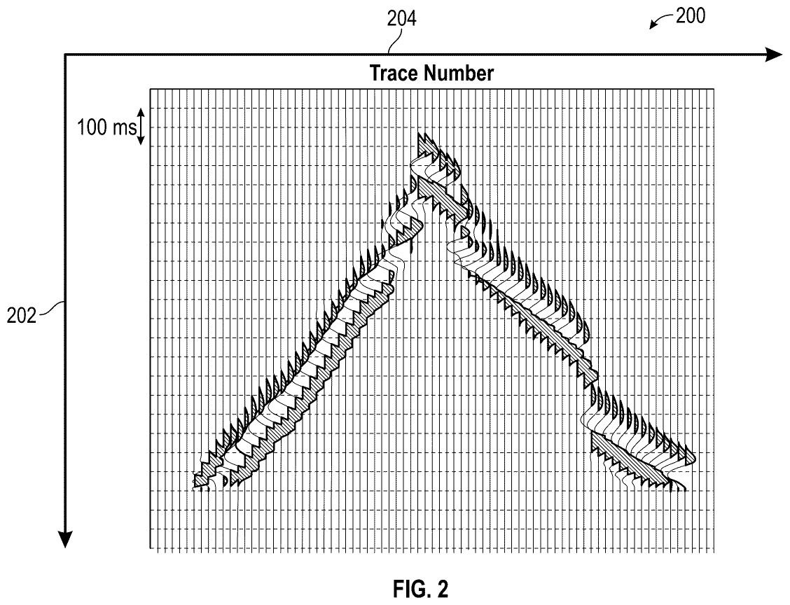

FIG. 2 is an illustration of a seismic shot gather (200), the recording of the firing or firings of a seismic source (106) at a single source location recorded at a range of seismic source to seismic receiver (120) separations or “offsets.” A seismic shot gather (200) represents a seismic data collection experiment where a source (106) is fired and the refracted seismic waves (110), reflected seismic waves (114), and ground roll seismic waves (118) are recorded at seismic receivers (120). The characteristics of seismic shot gathers (200) are affected by the geological structure of the subterranean region below the seismic survey (100). In one or more embodiments, FIG. 2 represents an idealized version of a seismic shot gather (200), where only a two reflection events occur, and ground roll and refracted waves have been muted. The amplitudes of the recorded seismic waves are displayed by the deviation of the signals from their centerlines; the recording time is indicated on the vertical axis (202) and the surface location is indicated on the horizontal axis (204). This idealized and muted version of seismic shot gathers (200) may be used in FWI as a way to improve results, but this does not limit the invention. Unedited seismic shot gathers (200) may also be used in FWI.

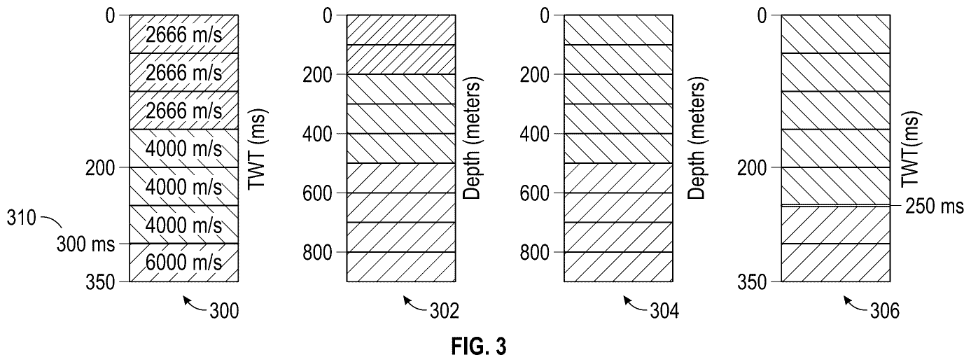

FIG. 3 demonstrates a scenario where the TWT of a reflectivity event is changed during conventional FWI. This occurs when a velocity model in TWT domain has been converted to the depth domain and used as the input velocity model for the FWI. Panel 300 shows the original velocity model as a function of TWT. Here, it is assumed that an event (310) of a reference layer is located at 300 ms. Panel 302 displays the corresponding regularly-sampled velocity model in depth, converted from TWT; this velocity model in depth is used as the initial velocity model for FWI. During an iteration of FWI, the velocity information in a shallow zone is changed from 2666 m/s to 4000 m/s, as show in Panel 304. Panel 306 shows the final velocity model converted back to TWT after the FWI; the event (310) has now been shifted to 250 ms. Therefore, the event (310) at 300 ms from the original, interpreted seismic image no longer ties after the velocity update in the shallow zone.

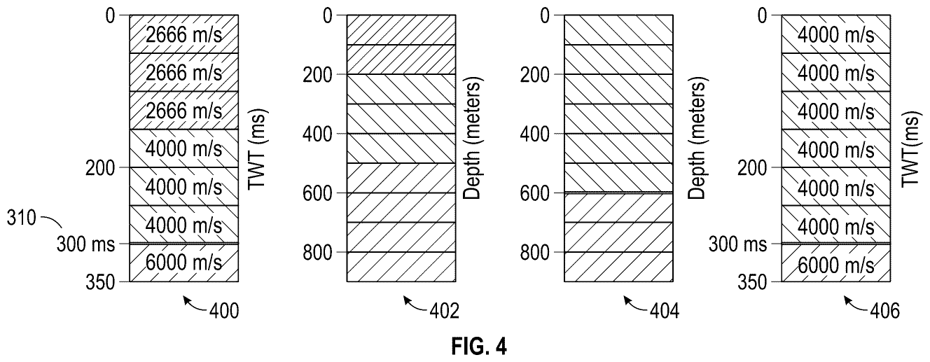

FIG. 4 shows a schematic process for the case shown in FIG. 3 when the TWT preserving methods are applied during the FWI process. Panel 400 is the same starting velocity model in TWT as shown in Panel 300. Panel 402 is the same velocity model in depth that is used in the initial iteration of the FWI as was shown in Panel 302. Panel 404, however, deviates from Panel 304. In this case, the depth-domain FWI model shown in Panel 404 has 4000 m/s velocity down to 600 m in depth. In this case, the TWT-preserving method has made the velocity in the shallow depths higher during FWI iterations, thus pushing the reference event deeper to compensate for the change in TWT. Finally, in Panel 406, the velocity model in depth is converted back to a velocity model in TWT. Here, the FWI has kept the event located at 300 ms (which is the same as it was in the original velocity model in TWT).

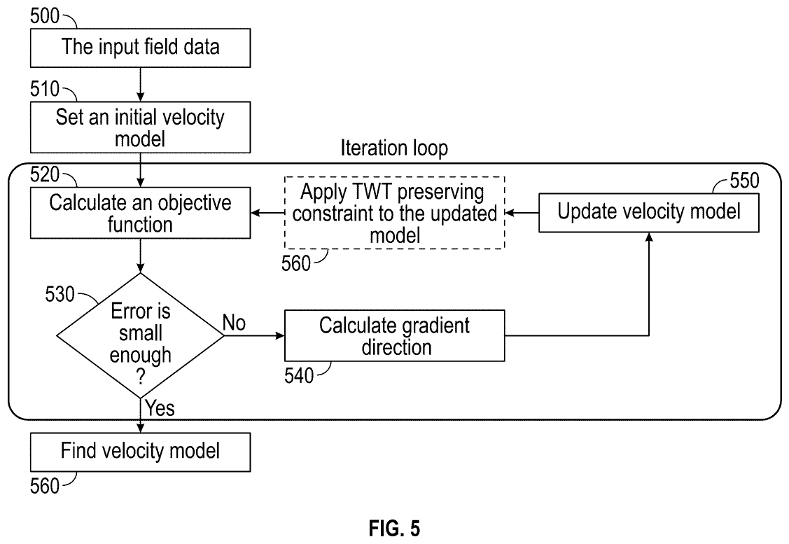

FIG. 5 shows a flow diagram where the TWT-preserving method is introduced into the FWI workflow. By applying the method on the updated velocity model at every iteration of the FWI, the original TWT information may be kept through all the FWI iterations. In Step 500, a seismic data set from the field is input onto a computer processor. In Step 510, an initial velocity model in depth is also input to the computer processor. This initial velocity model in depth may have come from a velocity model in TWT obtain, e.g., from migration velocity analysis. The origin of the initial velocity model in depth may be any method known to a person of ordinary skill in the art and does no limit the scope of this invention. In Step 520, an objective function is calculated that measures the magnitude of the difference between the observed seismic dataset and that modeled by the current velocity model. Different objective functions may be used. For instance, a simple L₂ norm is often chosen. The choice of objective function may be any known to a person of ordinary skill in the art and does not limit the scope of this invention. In Step 530, it is determined whether a stopping criterion related to the objective function has been reached. The stopping criterion may be (i) convergence—the objective function falls below some level, (ii) stagnation—the objective function stops decreasing significantly, or, (iii) a maximum number of iterations has been reached. These options do not limit the determination of when the FWI should stop, as other methods may exist.

If the error represented by the objective function has satisfied a stopping criterion, the method proceeds to Step 560, where a final velocity model is output and the workflow terminates. If the objective function has not met the stopping criterion, the workflow proceeds to Step 540, where a search direction of the objective function is calculated. For optimization of the objective function, a steepest descent method may be used as the search direction for the velocity update. However, this does not limit the invention. Other optimization techniques may be used, such as, e.g., gradient methods, as well as other methods known to a person skilled in the art. However, gradient-based methods present greater computational difficulty because they require re-computing gradient vectors of the velocity model with a TWT constraint applied. In Step 550, the velocity model is updated based on the search direction of the objective function.

In Step 560, the TWT-preserving constraint is applied to the velocity model. It proceeds by determining the TWT to every layer in a velocity model in depth during each iteration of FWI. Associating the velocity of each layer with each TWT value produces an irregularly sampled velocity model in TWT. This velocity model in TWT can then be interpolated onto a regularly sampled velocity model in TWT. Next, an irregularly sampled depth value is determined for each regularly sampled TWT interval, based on that layer's associated velocity value. Finally, the depth values are interpolated at regular intervals to produce a regularly sampled velocity model in depth. Step 560 guarantees that events interpreted in depth with a predetermined TWT maintain their TWT while the velocity model is being modified at each iteration of the FWI. After Step 560, the workflow returns to Step 520.

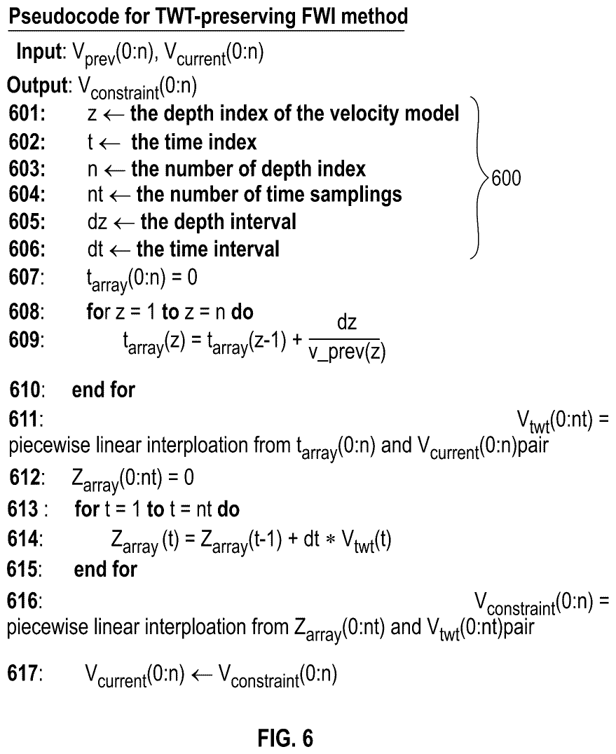

In FIG. 6, pseudocode for the TWT preserving method is presented. Two velocity models in depth are input into this pseudocode: Vₚᵣₑᵥ and V_{current}. Vₚᵣₑᵥ is the velocity model in depth before modification during an iteration of the FWI. V_{current} is the modification made to the velocity model in depth by the optimization method within the FWI. Lines 1 through 6 represent variable initialization (600) for variables z, t, n, nt, dz, and dt. These are, respectively, the depth index of the velocity model (601), the time index (602), the number of depth indices (603), the number of time samples (604), the depth interval (605), and the time interval (606). Line 607 initialized an array of time values to zero. Lines 608, 609, and 610 determine the TWT for each layer of a velocity model in depth. This is accomplished by integrating slowness (the reciprocal of velocity). Associating each TWT value with the velocity of the corresponding layer defines velocity model in TWT. Line 611 performs an interpolation of this irregularly sampled velocity model in TWT to produce a regularly sampled velocity model in TWT. The interpolation may be a piecewise linear interpolation but other methods of interpolation may be used, as well. Line 612 initializes an array of depth values the size of the number of velocity values in the regularly sampled velocity model in TWT. Lines 613, 614, and 615 determine the array of depth values by multiplying the velocity of each layer of the regularly sampled velocity model in TWT by the TWT of each interval. By associating each depth value in the array of depth values with the associated regularly sampled velocity model in TWT, one may define an irregularly sampled velocity model in depth. In Line 616, this irregularly sampled velocity model in depth is interpolated onto a regularly sampled velocity model in depth. In Line 617, V_{constraint} is assigned to V_{current}. This TWT-preserving method is repeated at each iteration of the FWI.

The TWT-preserving method may be applied at every x-y surface location corresponding to the 3D velocity model. The TWT-preserving method operates by keeping track of the velocity model in both depth and in TWT. Every time the velocity model is modified in depth by the FWI method, a new model is determined in TWT, and that new model in TWT is resampled onto a regular time interval. The depth of events interpreted in the seismic data can then be easily moved to new depth locations for each modified velocity model such that their TWT is the same as it was in the original velocity model in TWT.

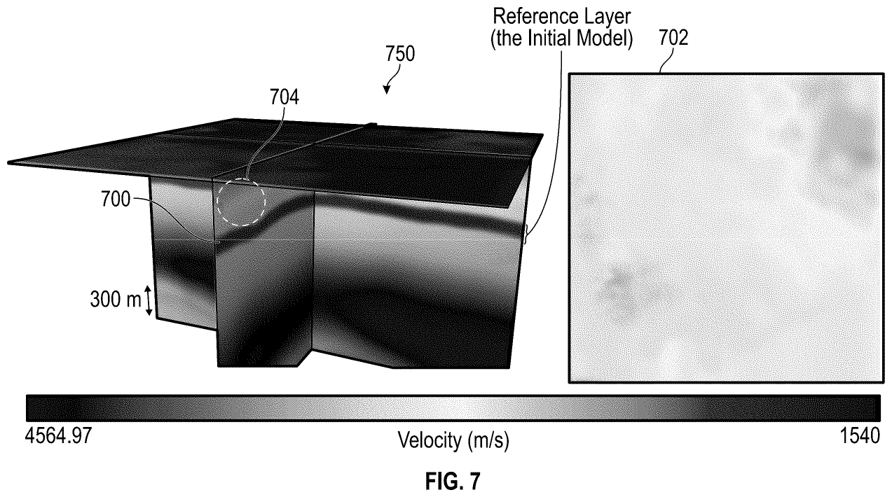

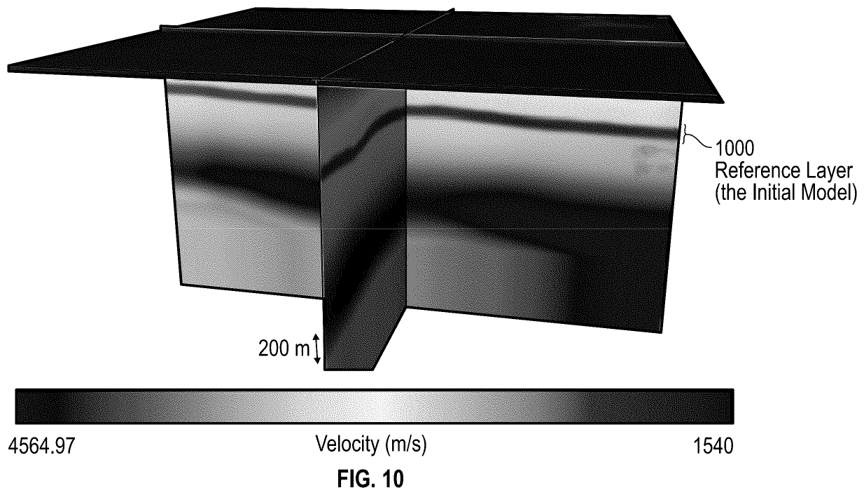

The FWI with the TWT-preserving method is compared to a conventional FWI for a 3D offshore dataset in FIGS. 7-12. Input parameters for this example of FWI include a maximum frequency of 12 Hz for the modeled seismic data, and offset ranges going from 100 m to 3,300 m. (FIG. 2, discussed above, displays a sample of a receiver gather used in the FWI). In FIGS. 7-9, velocity models on the left side of the figures are in depth. FIG. 7 shows the initial velocity model in depth (750) that is used in this test case. This initial model is obtained from the time-migrated-domain model (shown in FIG. 10) by using a time-to-depth conversion. A first representation of a reference layer (700) has been identified to compare the TWT-preserving method with the conventional FWI. A depth slice (702), at around 500 m, is shown on the right side of the figure. A first dashed circle (704) is shown for comparison purposes.

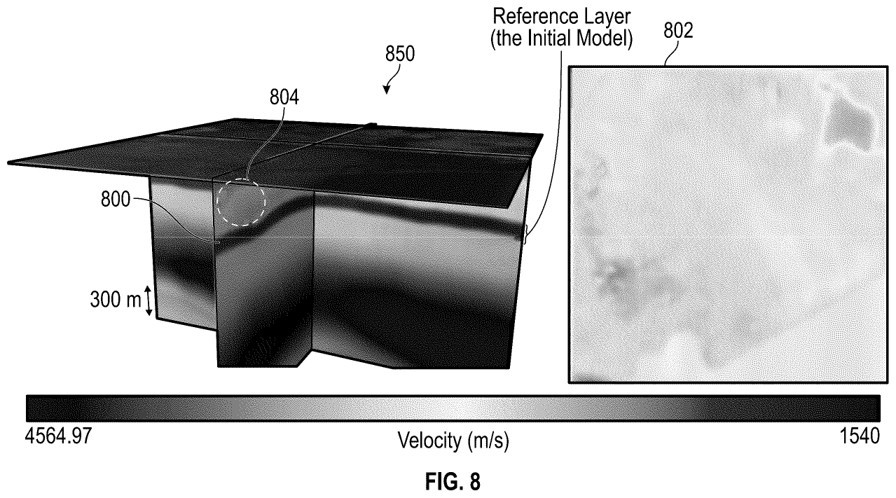

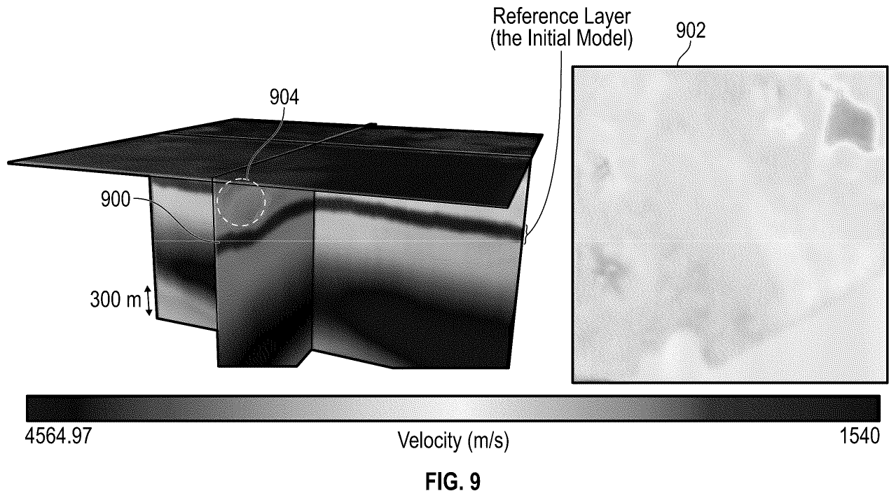

FIG. 8 shows the velocity model in depth obtained from the conventional FWI (850) at the 7th iteration. Comparing FIGS. 7 and 8, it may be seen that the velocity indicated by a second dashed circle (804) becomes faster compared to the velocity shown in the first dashed circle (704). The same change may be seen when comparing the first depth slice with the second depth slice (802). However, the depth of the first representation of a reference layer (700), denoted by ‘}’ symbol, is not changed when viewing the second representation of a reference layer (800) after the FWI. FIG. 9 displays the inverted model obtained from the proposed FWI workflow that includes the TWT-preserving method. The velocity indicated by the dashed circle (904) and seen in the third depth slice (902) become faster, which is the same effect as seen in the conventional FWI result. However, in this case, the depth location of the third representation of a reference layer (900) moves deeper in order to preserve the TWT of the event.

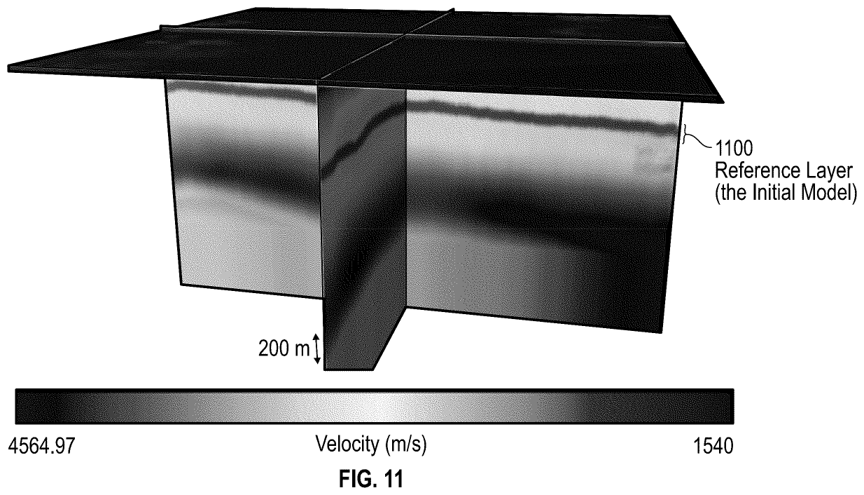

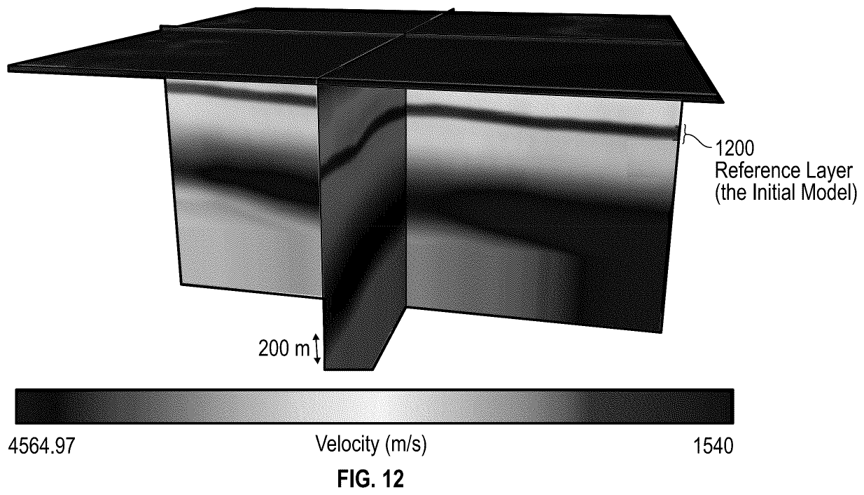

FIGS. 10-12 show velocity models in TWT, as opposed to in depth. Specifically, FIG. 10 shows the initial velocity model in TWT that was used to create the initial velocity model in depth (FIG. 7). A first representation in TWT of a reference layer (1000) is shown here for comparison of the results produced by conventional FWI with those produced by FWI with a TWT-preserving method. FIG. 11 displays the velocity model in TWT converted from the depth model determined by FWI after 7 iteration (shown in FIG. 8). It may be seen that the event location of a second representation in TWT of a reference layer (1100) in FIG. 11 is not the same as its original location in FIG. 10. It has moved up to an earlier TWT. On the other hand, in FIG. 12, the event location of a third representation in TWT of a reference layer (1200) in the velocity model in TWT (in this case, converted from the velocity model in depth obtained used the TWT-preserving method) is the same as the original event location.

The methods and systems proposed above should be applicable in all cases when an initial model is reasonably accurate. However, determining whether the results benefit from the new workflow requires a stacked seismic image that contains credible reflection layers to conduct analysis.

Furthermore, if the proposed FWI algorithm is carried out with a starting model that is too far from the earth velocity, then convergence using the TWT-preserving method may be slower than the results obtained using the traditional FWI workflow.

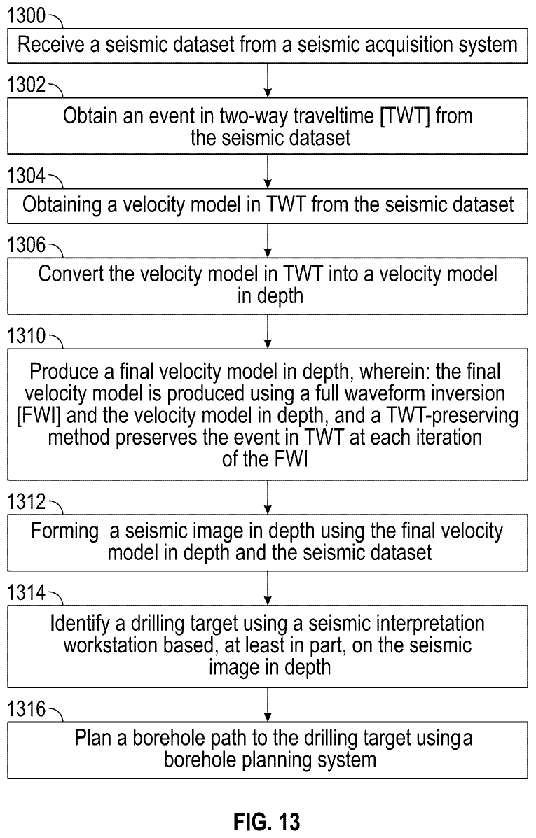

FIG. 13 presents a flowchart for the methods presented above. Initially, in Step 1300, a seismic dataset is received from a seismic acquisition system. The seismic dataset may be raw shot gathers, or else minimally processed shot gathers-possibly, with windows muting out noisy areas of the data. In Step 1302, an event in two-way traveltime [TWT] is obtained from the seismic dataset. This event may be a key stratigraphic boundary in the subsurface, but may also be another feature, such as, e.g., a fault. In Step 1304, a velocity model in TWT is obtained from the seismic dataset. This velocity model may have been obtained through a conventional migration velocity analysis, but this is not a limitation of the method. Any method for known to a person of ordinary skill in the art for obtaining an initial velocity model in TWT would be suitable. In Step 1306, the velocity model in TWT is converted into a velocity model in depth. This may be done by any method known to a person of ordinary skill in the art, such as by taking each location in map view, and determining the thickness of every layer in the depth direction, and then re-interpolating the irregularly sampled velocity model in depth onto a regularly sampled grid. In Step 1310, a final velocity model in depth is produced by using FWI along with the velocity model in depth; a TWT-preserving method preserves the event in TWT at each iteration of the FWI. In this way the TWT of an event interpreted in the TWT domain remains constant throughout the FWI. In Step 1312, a seismic image is formed in depth using the final velocity model in depth (coming out of the FWI along with the TWT-preserving method) and the seismic dataset. In Step, 1314, a drilling target may be identified using a seismic interpretation workstation based, at least in part, on the seismic image in depth. The drilling target may be chosen, e.g., based on the its probability of containing hydrocarbons. In Step 1316, a borehole path is planned to the drilling target using a borehole planning system.

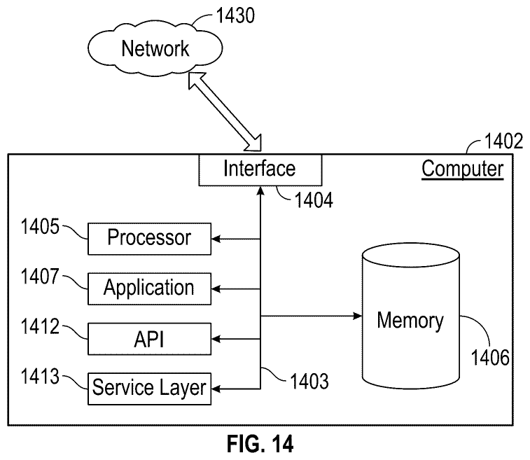

FIG. 14 further depicts a block diagram of a computer system (1402) used to provide computational functionalities associated with described algorithms, methods, functions, processes, flows, and procedures as described in this disclosure, according to one or more embodiments. The illustrated computer (1402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1402) may include an input device, such as a keypad, keyboard, touch screen, or other device that can accept user information, and an output device that conveys information associated with the operation of the computer (1402), including digital data, visual, or audio information (or a combination of information), or a GUI.

The computer (1402) can serve in a role as a client, network component, a server, a database or other persistency, or any other component (or a combination of roles) of a computer system for performing the subject matter described in the instant disclosure. The illustrated computer (1402) is communicably coupled with a network (1430). In some implementations, one or more components of the computer (1402) may be configured to operate within environments, including cloud-computing-based, local, global, or other environment (or a combination of environments).

At a high level, the computer (1402) is an electronic computing device operable to receive, transmit, process, store, or manage data and information associated with the described subject matter. According to some implementations, the computer (1402) may also include or be communicably coupled with an application server, e-mail server, web server, caching server, streaming data server, business intelligence (BI) server, or other server (or a combination of servers).

The computer (1402) can receive requests over network (1430) from a client application (for example, executing on another computer (1402)) and responding to the received requests by processing the said requests in an appropriate software application. In addition, requests may also be sent to the computer (1402) from internal users (for example, from a command console or by other appropriate access method), external or third-parties, other automated applications, as well as any other appropriate entities, individuals, systems, or computers.

Each of the components of the computer (1402) can communicate using a system bus (1403). In some implementations, any or all of the components of the computer (1402), both hardware or software (or a combination of hardware and software), may interface with each other or the interface (1404) (or a combination of both) over the system bus (1403) using an application programming interface (API) (1412) or a service layer (1413) (or a combination of the API (1412) and service layer (1413)). The API (1412) may include specifications for routines, data structures, and object classes. The API (1412) may be either computer-language independent or dependent and refer to a complete interface, a single function, or even a set of APIs. The service layer (1413) provides software services to the computer (1402) or other components (whether or not illustrated) that are communicably coupled to the computer (1402). The functionality of the computer (1402) may be accessible for all service consumers using this service layer. Software services, such as those provided by the service layer (1413), provide reusable, defined business functionalities through a defined interface. For example, the interface may be software written in JAVA, C++, or other suitable language providing data in extensible markup language (XML) format or another suitable format. While illustrated as an integrated component of the computer (1402), alternative implementations may illustrate the API (1412) or the service layer (1413) as stand-alone components in relation to other components of the computer (1402) or other components (whether or not illustrated) that are communicably coupled to the computer (1402). Moreover, any or all parts of the API (1412) or the service layer (1413) may be implemented as child or sub-modules of another software module, enterprise application, or hardware module without departing from the scope of this disclosure.

The computer (1402) includes an interface (1404). Although illustrated as a single interface (1404) in FIG. 14, two or more interfaces (1404) may be used according to particular needs, desires, or particular implementations of the computer (1402). The interface (1404) is used by the computer (1402) for communicating with other systems in a distributed environment that are connected to the network (1430). Generally, the interface (1404) includes logic encoded in software or hardware (or a combination of software and hardware) and operable to communicate with the network (1430). More specifically, the interface (1404) may include software supporting one or more communication protocols associated with communications such that the network (1430) or interface's hardware is operable to communicate physical signals within and outside of the illustrated computer (1402).

The computer (1402) includes at least one computer processor (1405). Although illustrated as a single computer processor (1405) in FIG. 14, two or more processors may be used according to particular needs, desires, or particular implementations of the computer (1402). Generally, the computer processor (1405) executes instructions and manipulates data to perform the operations of the computer (1402) and any algorithms, methods, functions, processes, flows, and procedures as described in the instant disclosure.

The computer (1402) also includes a memory (1406) that holds data for the computer (1402) or other components (or a combination of both) that can be connected to the network (1430). For example, memory (1406) can be a database storing data consistent with this disclosure. Although illustrated as a single memory (1406) in FIG. 14, two or more memories may be used according to particular needs, desires, or particular implementations of the computer (1402) and the described functionality. While memory (1406) is illustrated as an integral component of the computer (1402), in alternative implementations, memory (1406) can be external to the computer (1402).

The application (1407) is an algorithmic software engine providing functionality according to particular needs, desires, or particular implementations of the computer (1402), particularly with respect to functionality described in this disclosure. For example, application (1407) can serve as one or more components, modules, applications, etc. Further, although illustrated as a single application (1407), the application (1407) may be implemented as multiple applications (1407) on the computer (1402). In addition, although illustrated as integral to the computer (1402), in alternative implementations, the application (1407) can be external to the computer (1402).

There may be any number of computers (1402) associated with, or external to, a computer system containing computer (1402), wherein each computer (1402) communicates over network (1430). Further, the term “client,” “user,” and other appropriate terminology may be used interchangeably as appropriate without departing from the scope of this disclosure. Moreover, this disclosure contemplates that many users may use one computer (1402), or that one user may use multiple computers (1402).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
acquiring, using a seismic acquisition system, a seismic dataset;
using a seismic processor:
obtaining, from the seismic dataset, an event in two-way traveltime (TWT),
obtaining, from the seismic dataset, a velocity model in TWT,
converting the velocity model in TWT into a velocity model in depth,
producing a final velocity model in depth, wherein:
the final velocity model is produced using a full waveform inversion (FWI) and the velocity model in depth; and
a TWT-preserving method preserves the event in TWT at each iteration of the FWI, and
forming a seismic image in depth using the final velocity model in depth and the seismic dataset;
identifying, using a seismic interpretation workstation and based, at least in part, on the seismic image in depth, a drilling target; and
planning, using a borehole planning system, a borehole path to the drilling target.

2. The method of claim 1, further comprising drilling, using a drilling system, the borehole path to the drilling target.

3. The method of claim 1, wherein, at each iteration of FWI, the TWT-preserving method comprises re-interpolating the velocity model in depth.

4. The method of claim 1, wherein, at each iteration of the FWI, the TWT-preserving method comprises re-interpolating the velocity model in TWT.

5. The method of claim 3, wherein the re-interpolation of the velocity model in depth is a piecewise-linear re-interpolation.

6. The method of claim 4, wherein the re-interpolation of the velocity model in TWT is a piecewise-linear re-interpolation.

7. The method of claim 1, wherein the TWT-preserving method is applied at each of a plurality of surface locations above the velocity model in depth.

8. The method of claim 1, wherein the event was determined from a time-migrated seismic dataset.

9. The method of claim 1, wherein an optimization method of an objective function in the FWI is a steepest descent method.

10. The method of claim 1, wherein the velocity model in TWT is obtained from a migration velocity analysis.

11. A system, comprising:
a seismic acquisition system, configured to acquire a seismic dataset;
a seismic processor, configured to:
receive the seismic dataset from the seismic acquisition system;
obtain, from the seismic dataset, an event in two-way traveltime (TWT),
obtain, from the seismic dataset, a velocity model in TWT,
convert the velocity model in TWT into a velocity model in depth,
produce a final velocity model in depth, wherein:
the final velocity model is produced using a full waveform inversion (FWI) and the velocity model in depth; and
a TWT-preserving method preserves the event in TWT at each iteration of the FWI; and
form a seismic image in depth using the final velocity model in depth and the seismic dataset;
a seismic interpretation workstation, configured to identify a drilling target based, at least in part, on the seismic image in depth; and
a borehole planning system, configured to plan a borehole path to the drilling target.

12. The system of claim 11, further comprising drilling, using a drilling system, the borehole path to the target.

13. The system of claim 11, wherein, at each iteration of FWI, the TWT-preserving method comprises re-interpolating the velocity model in depth.

14. The system of claim 11, wherein, at each iteration of the FWI, the TWT-preserving method comprises re-interpolating the velocity model in TWT.

15. The system of claim 13, wherein the re-interpolation of the velocity model in depth is a piecewise-linear re-interpolation.

16. The system of claim 14, wherein the re-interpolation of the velocity model in TWT is a piecewise-linear re-interpolation.

17. The system of claim 11, wherein the TWT-preserving method is applied at each of a plurality of surface locations above the velocity model in depth.

18. The system of claim 11, wherein the event was determined from a time-migrated seismic dataset.

19. The system of claim 11, wherein an optimization method of an objective function in the FWI is a steepest descent method.

20. The system of claim 11, wherein the velocity model in TWT is obtained from a migration velocity analysis.
